(19) United States
(12) Patent Application Publication
(10) Pub. No.: US 2009/0236804 A1
(43) Pub. Date: Sep. 24, 2009

(54) Playing Cards with Electronic Circuitry

(76) Inventor: Daniel Kirsch, Incline Village, NV (US)

Correspondence Address: LOUIS VENTRE, JR, 2483 OAKTON HILLS DRIVE, OAKTON, VA, 22124-1530, US

(21) Appl. No.: 12/052,107

(22) Filed: Mar. 20, 2008

(51) Int. Cl. A63F 1/02; G06K 19/067

(52) U.S. Cl. 273/295; 235/492

(57) ABSTRACT

A playing card for a game is constructed in layers and is electrically conductive through internal electronic circuitry. The electronic circuitry is electrically energized to generate an electrical signal that identifies suit and face value of the playing card. The electronic circuitry generates an electrical signal and sends it to an adjacent playing card in a deck. That card in turn appends its indicia to the signal and transmits the new signal to the next card in the deck and so on to the bottom card, thus, preserving the order of the cards. A dealing shoe, a cut-card and an image displaying card may be used in conjunction with the playing cards.

### FIELD OF INVENTION

In the field of amusement devices, a playing card is disclosed having a means for processing electronic data that may be used to identify the suit and face value of the playing card and its relative position in a stack of playing cards.

### BACKGROUND OF THE INVENTION

The present invention offers a unique, non line-of-sight system for identifying the suit, value and sequence of playing cards in a stack of playing cards by energizing electronic circuitry within each card using conductive contact surfaces on each card.

There is a need for such playing cards in a casino environment, for instance, to ensure that a full deck is being used and that cards are not missing from a deck after being used in a card game. If a card has been added or removed from the game illegally by a participant, the system can detect the infraction.

There is a further need for such playing cards in a casino environment to monitor game activity and card distribution by monitoring the cards in the deck and determining those cards dealt to the participants.

### DESCRIPTION OF PRIOR ART

Techniques are currently available in order to enable one to identify a playing card's suit and face value. Optical technologies have been suggested to “read” the cards including, camera imaging, barcode, optoelectrical (photodiode), encoded inks, edge marking, etc.

An example of edge marking is U.S. Pat. No. 7,222,852 teaching a method, apparatus and article employing multiple machine-readable indicia along the edge of playing cards. A further example teaching use of a scanner in a card-dispensing shoe is U.S. Pat. No. 6,582,301. The scanner discerns the value and suit of each card dispensed. The present invention does not use edge markings or optical scanners, or any of the other line of sight techniques found in the prior art.

A non line-of-sight technology, such as Radio Frequency Identification (RFID), is an available technology. For example, U.S. Pat. No. 5,941,769 teaches using an RFID-system with game chips having an integrated transponder. The present invention does not use RFID in game chips or playing cards. The present invention is unique in the use of a conductive playing card with electronic circuitry wherein supplying electrical energy directly to the card, eliminates the need for a radio frequency antenna on each card.

Imprinted antenna and electronic circuitry are known in other applications. Embodiments of the present invention use these technologies in a cut-card in a manner not disclosed in the prior art. A cut-card is a card of similar dimension to a playing card that is inserted by a player into a stack of cards to divide the deck into two parts wherein the top part of the deck is placed on the bottom, and the bottom part of the deck is placed on the top, with the cut card ending up on the bottom of the stack.

Therefore, the present invention serves to provide an improved means for security in casino card games and an improved means for monitoring cards in the deck and the cards discarded in a discard rack.

### BRIEF SUMMARY OF THE INVENTION

A playing card for a game is constructed in layers and is electrically conductive through the internal electronic circuitry. The electronic circuitry can be electrically energized to generate an electrical signal that identifies suit and face value of the playing card. Preferably, electrical contact surfaces on the outer layers are in a fixed position such that when they are in a deck, all the contact surfaces align. When the electronic circuitry in a playing card is electrically stimulated, it generates a unique electrical signal and sends it to an adjacent playing card in the deck. That card in turn appends its indicia to the signal and transmits that signal to the next card in the deck and so on to the bottom card, thus, preserving the order of the cards within the signal.

When the cards are dealt from a shoe, the shoe provides an electrical connection between the top and bottom card and provides electricity to energize the contact surfaces of the cards. The shoe includes an electrical receiver to obtain the final electrical signal from the bottom card in the deck, and a radio transmitter to wirelessly transmit that electrical signal to a receiver at a remote location where a computer then analyzes the electrical signal and provides a user interface.

When a player holds the cards, an image-displaying card may be used to display an image of the cards held by a player. The image-displaying card is similarly made in layers and has a transparent layer with means for displaying an image of a playing card when energized through a contact surface, the electrical circuit being completed by the hand of a player holding the cards, by using a conductive clip to hold the cards, or by using a conductive glove. The playing cards may include an imprinted battery to energize the circuitry, display and contact surfaces, or the cut-card may include the battery.

The playing cards may be used with a cut-card such that the cut-card is at the bottom of a stack of cards being held by a dealer. The cut-card of the present invention is a layered card and also has contact surfaces that are electrically conductive. It has an antenna that is preferably adjacent to an electromagnetic field absorbing layer. The antenna typically is a length of wire having two ends, wherein the wire is wound around the perimeter of the cut-card with one end of the wire connected to an inner semi conductive layer and the other end of the wire connected to a contact surface. The antenna receives and transmits a radio frequency signal. The cut-card receives an electrical signal from a playing card and the antenna generates a radio frequency signal for transmission to a remote receiver. Contact surfaces on the cut-card are preferably surrounded by an insulating portion around the perimeter edge. Cut-card layers may be electrically conductive; semi-conductive; or dielectric.

### BRIEF DESCRIPTION OF THE DRAWINGS

The reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is an exploded side view of a preferred embodiment of a playing card showing layers according to the invention.

FIG. 2 is a side view of a shoe holding a deck of playing cards according to one aspect of the invention.

FIG. 3 is a representation of a radio base station, computer and monitor according to one aspect of the invention.

FIG. 4 is a top view of a preferred embodiment of a playing card according to the invention.

FIG. 5 is a top view of two playing cards rotated with respect to each other according to one aspect of the invention.

FIG. 6 is a bottom view of a preferred embodiment of a cut-card with a radio frequency antenna.

FIG. 7 is an exploded side view of an alternative embodiment of a cut-card showing layers with a radio frequency antenna according to the invention.

FIG. 8 is a perspective of a glove with a conductive coating.

FIG. 9 illustrates an exploded side view of a preferred embodiment of an image displaying card.

FIG. 10 is a perspective of a preferred embodiment of an electrically conductive clip that may be used to hold a hand of playing cards.

FIG. 11 is an exploded side view of an alternative embodiment of a substrate and imprinted circuitry according to the invention.

### DETAILED DESCRIPTION

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural and operational changes may be made without departing from the scope of the present invention.

A preferred embodiment of the invention includes the usual features of a playing card: It has a top side and a bottom side and the bottom side has indicia, such as suit and value, unique to the playing card.

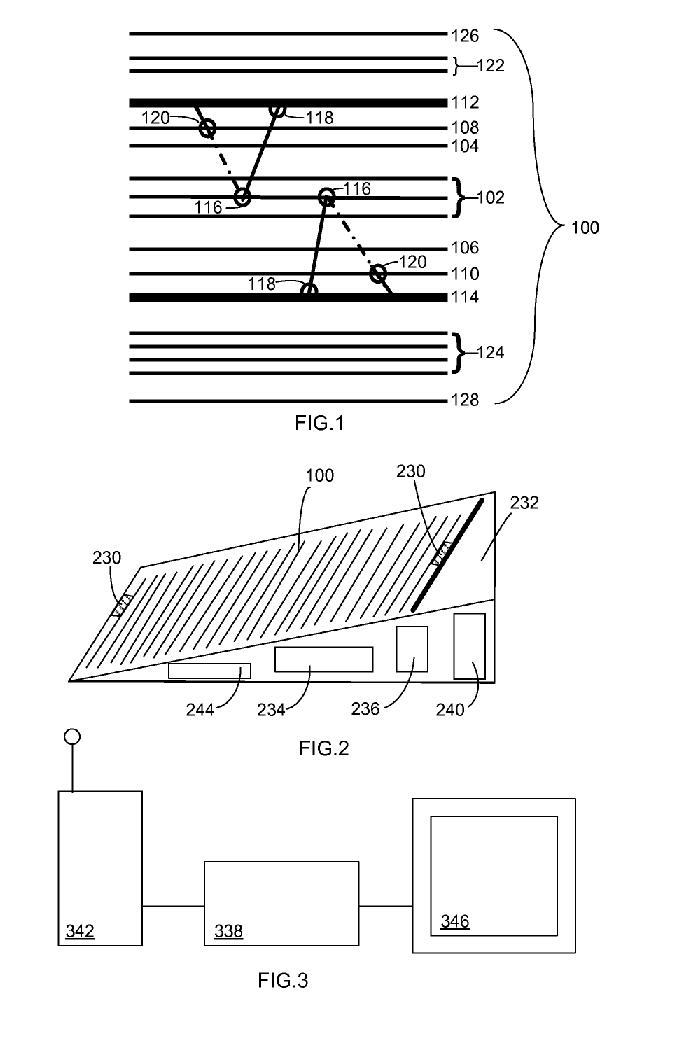

FIG. 1 illustrates an exploded side view of such an exemplary embodiment of a playing card (100). Shown are a plurality of layers comprising an outer layer on the top side, in this case a clear plastic semi conductive surface layer (126) and an outer layer on the bottom side, in this case clear plastic semi conductive surface layer (128).

FIG. 1 shows each outer layer (126 and 128) in the whole as a contact surface, however the perimeter of each outer layer may be non-conductive. Thus, each contact surface is applied to a portion of a layer such that an edge of the playing card is non-conductive.

Also, edges of the playing card may have a non-conductive coating so that layers in each playing card do not short-out by a dealer's hand. Shorting-out is not a concern when the deck is dealt from a shoe. Preferably, the last two layers on the top or bottom side of a playing card are a conductive ink layer and the conductive plastic surface layer. These are most easily printed over the entire surface of the playing card. For example, it would be possible but less practical to print the indicia using conductive ink at the center conductive area, and then print the area around that with non-conductive ink.

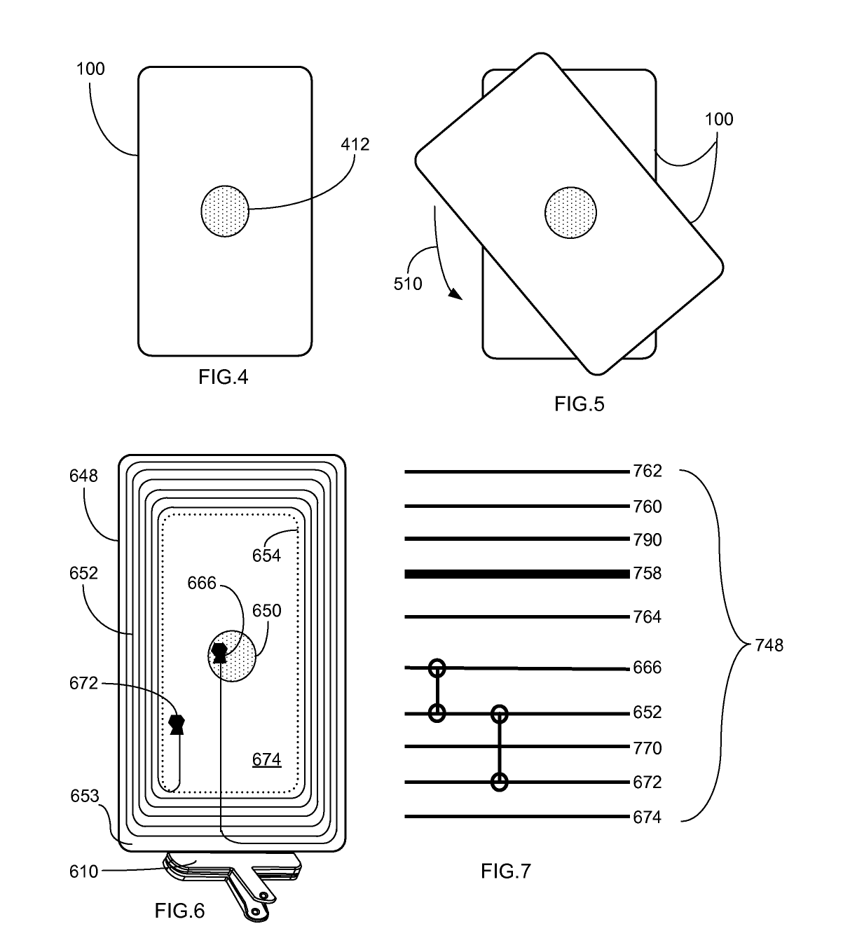

The term non-conductive is used herein interchangeably with the term insulating and with the term dielectric. Preferred embodiments, such as shown in FIG. 4, have only a portion (412) through the substrate of the playing card serving as an electrically conductive conduit from one side of the card substrate to the other. A substrate is a base layer and when used in reference to a playing card, is the base layer of the playing card.

Embodiments of the invention include at least one electronic circuitry layer, preferably comprised of a number of layers. FIG. 1 shows a preferred embodiment with 3 electronic circuitry layers (102), however the invention includes embodiments using more than three such layers. Each such imprinted circuitry layer may have conductive, semi-conductive, or dielectric characteristics. The preferred method for applying electronic circuitry layers (102) to the card substrate is by printing each layer in a production line utilizing established printing methods used in the production of field effect transistors, also known as FETs. The technology for such imprinted electronic circuitry layers is well known in the art.

It is preferred to print the electronic circuitry onto a substrate. Other methods may be used to include the electronic circuitry. An example of an analogous method known in the art is described in U.S. patent publication 20060290498 A1, entitled “Incorporation of RFID devices into labels.” It discloses a cavity in a laminated structure, into which an RFID device is placed, without increasing the thickness of the structure. An example of a possibly suitable method of making the electronic circuitry is described in an article entitled “RFID ‘Powder’-Worlds Smallest RFID Tag” found at http//www.technovelgv.com, which describes a transponder measuring only 0.05 mm×0.05 mm, having a 128-bit ROM, with a capability of storing a 38-digit serial number. These nano sized transponders could be placed within the paper or plastic substrate material that most cards are made from, and utilizing the disclosed conductive layering techniques of the present invention, an electrical signal can be passed from one surface of a card and through a transponder to its opposite surface, and from the surface of one card to the surface of another, maintaining card identifier information in sequence.

The electronic circuitry is electrically connected between the contact surfaces such that when a contact surface is electrically energized the electronic circuitry generates an electrical signal that identifies the indicia of the playing card. Electrically energized means applying a voltage such that current flows through the circuitry.

For preferred embodiments, the electronic circuitry further includes means for receiving an electrical signal from a playing card adjacent to it in the deck and transmitting a new electrical signal with the indicia of the playing card in which the electronic circuitry is located appended to the electrical signal received. This electronic circuitry is similar to that described in U.S. Pat. No. 6,870,180, which is incorporated by reference herein in its entirety.

FIG. 1 shows optional insulating layers (104) and (106). Above and below these layers are optional solid, conductive-contact layers (108) and (110), respectively. Above and below these layers (108) and (110) are semi-conductive layers (112) and (114), respectively.

At least one layer of a playing card (100) is a layer comprising a semi conductive portion (112) or (114). The layer comprising a semi conductive portion (112) or (114) has a semi conductive portion that is highly conductive and can conduct electrical current through the card substrate. Semi conductive portion (112) or (114) may comprise paper, plastic, polymeric or small molecule compounds, or any other suitable material readily mixable with conductive nano-sized metal particles. Methods for making such layers are well known in the art.

Electronic circuitry layers (102) are electrically connected to the layer comprising a semi conductive portion (112) or (114) by contact points (116) and (118). Alternately, when conductive, contact layers (108) and (110) are used, contact points (116) and (120) may be established in order to positively connect electronic circuitry layers (102) with the layer comprising a semi conductive portion (112) or (114). In FIG. 1, contact points (116) are shown connecting to the center layer, however electronic circuitry layers (102) may be so configured such that contact points (116) attach to layers other than the center layer.

Above and below layer comprising a semi conductive portion (112) or (114) are semi conductive ink layers (122) and (124). FIG. 1 shows two conductive ink layers (122) consisting of two colors of conductive ink making up the back (top side) design of a playing card. However, a single layer of conductive ink may be adequate to pass current vertically through the card. The colors of conductive ink available are defined mostly by the base colors of the conductive elements mixed within, those base colors nonexclusively including; clear (water white), black, silver, copper, brass, and gold. Four color layers (124) consist of four colors of conductive ink making up the face indicia on the playing card, however as discussed above, a single layer of conductive ink may be adequate, while other layers may consist of regular pigmented ink.

Above and below semi conductive ink layers (122) and (124) are optional clear plastic semi conductive surface layers (126) and (128). Clear plastic semi conductive surface layers (126) and (128) are electrically conductive and can pass electrical current from semi conductive ink layers (122) and (124) to the surface of the card; and from surface to surface. Therefore, electrical signals can be transferred from the surface of one card to the surface of another.

As shown in the preferred embodiment illustrated in FIG. 1, the playing card has a plurality of layers and is preferably symmetrical in layer construction: it is preferably constructed similarly from top to middle as from bottom to middle. The top side half from top to midpoint comprises: an outer layer of clear semi conductive plastic material (126); a semi-conductive ink layer (122); a layer comprising a semi conductive portion (112), which may serve as a substrate; an optional conductive contact layer (108); an optional insulating layer (104); and, electronic circuitry that is electrically connected to the layer comprising a semi conductive portion (112). Three electronic circuitry layers (102) are shown in FIG. 1. Although two substrates (semi conductive portions 112 and 114) are shown in FIG. 1, a single substrate will suffice. In that configuration, the second substrate layer (semi conductive portion 112 or 114) may be substituted for a semi conductive, fill-in film layer, such as the fill-in semi conductive surface layer (674) discussed below. The final surface of the semi-conductive fill-in film layer may be textured to resemble the texture of a paper playing card, yet the surface should be smooth enough to be able to print the indicia. In FIG. 1, if a single substrate configuration is used, semi conductive layer (112) or (114) may also be substituted with a conductive contact layer (108) or (110). In general, throughout this application a semi conductive layer has electrically conductive characteristics and could be substituted by a more conductive layer as long as layers (112) and (114) have a higher conductivity than subsequent outside layers.

Each layer shown in FIG. 1 may consist of one or more layers having conductive, semi-conductive, or dielectric properties, and although FIG. 1 shows each layer extending all the way across the card, it is contemplated that the layers may be applied to specific, limited areas of the card. Additionally, any combination of layers may be used in order for the cards to obtain conductibility, as well as logistic and sequence retaining capabilities.

In FIG. 2, two electrical contact points (230) are provided within a shoe (232), commonly used for dealing one or more decks of playing cards, in order to provide electrical current to the stack of cards located in the shoe, and to accept an electrical signal from the cards at the other end of the stack. One electrical contact point (230) makes contact with the top surface of the top card, while the other contact point (230) makes contact with the bottom surface of the bottom card in the stack. A deck of playing cards typically includes up to 52 playing cards, each with unique indicia comprising a suit and a face value.

For preferred embodiments, an amusement game with a shoe (232) first includes an energy source to electrically energize the contact surfaces of all the cards in the deck by applying an electrical potential difference between the contact surfaces on the top and bottom playing cards in the deck. This is typically a battery (244) providing DC power, or a direct connection to a standard A/C electrical outlet.

It next includes a transceiver (234), shown in FIG. 2, to send electrical current to one of the electrical contact points (230) and receive an electrical signal indicating playing card indicia and sequence information from the other electrical contact point (230). Thus, the transceiver (234) is electrically connected to electrical contact points (230) and is also configured to regulate the current applied to the playing cards.

The transceiver (234) is preferably configured to energize the cards every fraction of a second in a repetitive manner. The first playing card to be energized, at one end of the stack, will send a unique identifying signal response to its adjacent playing card. When an identifying response is received by the adjacent playing card, its own identifying response is added, i.e. appended, to the electrical signal to be sent to the next adjacent playing card. This sequence is adhered to by all of the playing cards in the stack until a representative sequence is established at the far end of the stack of playing cards.

The shoe (232) next includes a means for relaying to a computer the electrical signal. Preferably this means for relaying is a radio transmitter (240) to wirelessly transmit to a receiver (342) a radio signal comprising the indicia and sequence information indicated by the electrical signal. The receiver (342) may be located remotely at a secure location. Optionally, the shoe (232) is hard-wired to system computer (338).

The receiver (342) is connected to a computer (338) configured to analyze the signal received from the means for relaying the electrical signal and interface with a user. The receiver may be radio base station (342) or simply a peripheral attachment to the computer (338).

The shoe (232) may optionally incorporate microchip circuitry (236) having logistic and time recognition capabilities, and/or such capabilities may be configured within the computer (338), shown in FIG. 3.

A computer preferably has code means for logistics and time recognition; for interacting with a user; and for displaying on a monitor screen (346) specific information derived from the received electrical signal. The monitor screen is shown as a separate component, but is typically considered part of a computer.

The code means will preferably correlate the indicia of each playing card (100) in its sequence in the deck; identify a playing card (100) that has been dealt from the shoe (232) by its absence from the deck; and determine the order of a group of playing cards (100) that have been dealt.

The specific information derived from the received electrical signal includes for example, the order of the stack of cards. This order can be interpreted by the computer to display each player's or participant's projected initial hand as if the next playing card (100) dealt would begin an initial round of cards, making up the next round of initial hands. As each playing card is dealt from the shoe (232), the computer code means would re-calculate each participant's future initial hand and display each participant's re-calculated future initial hand on the monitor.

The code means preferably determines the number of participants receiving initial hands by examining the pace of the deal, or how fast cards are being dealt from the shoe, similar to that which is described in one of applicant's prior patent applications. When the cards are being dealt at a continual speed faster than a predetermined amount of time per card, such as one dealt card per second, the system computer will determine that the sequence of quickly dealt cards are being dealt as initial hands. When the cards are being dealt at a slower pace, at a speed less than a pre-determined amount of time per card, such as less than one card dealt per second (or with longer intervals between a dealt card and the preceding card dealt), then the system computer code means may determine the dealt card to be a card dealt to a hand after the initial deal.

At the beginning of each deal, the code means would show the computer user the initial hands that will be dealt on the next round according to the number of participants or “hands” that the system computer has determined are at the gaming table. Occasionally during play, the code means may be wrong in its determination of the number of hands that have been played. In that case, the code means would enable casino personnel or another user to enter the actual number of hands being played at the table so that the system code means can re-calculate the initial hands for the next round. After one or more manual corrections, the code means automatically re-sets the predetermined amount of time in which a dealt card is determined to be a card dealt to an initial hand. Therefore, the predetermined amount of time distinguishing a card dealt to an initial hand from a card dealt to a hand after the initial deal, would be re-set from one card dealt per second in the example, to one card dealt per 0.75 seconds, or one card dealt per 1.25 seconds depending upon which way the time indicator needs to be adjusted, according to a dealer's dealing speed, in order for the system to give a more accurate representation of the number of participants at the table.

Each dealer has a different dealing speed, and a specific predetermined time indicator distinguishing a card dealt to an initial hand may be assigned to each dealer. When a dealer first steps up to the table, he may be required to register with the system computer by punching a keyboard number or symbol into the system computer, or swiping an identification tag across a reader located at the game table. In this manner, the code means in the system computer can adjust its dealing speed indicators accordingly and the number of participants can be determined by the code means more accurately and in more instances. A computer keyboard may also provide a manual control allowing adjustment of the dealing speed indicator. The computer keyboard or other user input device enables manual control of the code means and may be located in a remote secure location.

The code means takes into account a number of factors when trying to determine the number of participants at the table, the speed of the deal being one example of them. Another factor that the code means considers is the rhythm of the cards being removed from the shoe. Cards that are dealt from a shoe to the initial hands are usually dealt in a fluid, unbroken rhythm, while cards dealt after the initial hands, are usually dealt in a broken irregular rhythm.

Another factor taken into consideration by the code means when trying to determine the number of participants at the table is the number of quick deals that are followed by a longer interval before the next deal. Many dealer games, versus player games, require at least two participants who each receive two cards during the initial deal. For example, if, after a number of cards have been dealt, two quick two-card deals are detected, followed by a long pause, the code means would use the pause or pauses to determine how many cards were dealt to the initial hands and calculate that an initial deal was at least four cards dealt in a quick fluid manner.

Another factor, taken into consideration by the code means when calculating the number of hands being played, is a previous determination of the number of hands that have been played a few seconds earlier.

Alternately, a button or touch activated device may be located on a dealing shoe (232), or at the game table, to be manually pressed by the dealer at the beginning and/or at the end of each new round, and/or when one player has finished asking for cards and another participant is about to take an additional card, and/or in split situations when cards are originally split and/or when the next card dealt will be placed on the following hand.

The layers of a playing card include one or more substrate layers comprising a semi conductive portion. The semi conductive portion may be the entirety of one or more of the layers (112) and (114). In FIG. 1, a layer comprising a semi conductive portion (112) and another layer comprising a semi conductive portion (114) are shown extending all of the way across the playing card (100), wherein the semi conductive portion is the entire layer. However, as is illustrated in FIG. 4, this semi conductive portion may comprise a circular or other geometric shape on the layer. Thus, layer comprising a semi conductive portion (112) or (114) preferably has only a portion that is semi conductive and that portion comprises contact surfaces located at the symmetrical center of the playing card, as is shown in FIG. 4 at portion (412). Portion (412) is representative of either a layer comprising a semi conductive portion (112) or a layer comprising a semi conductive portion (114) located on the other side of playing card (100) and may comprise a larger or smaller portion of playing card (100) than that shown.

Each layer comprising a semi conductive portion (112) or (114) creates an electrical conduit from one layer to another, from the top surface of a layer to the bottom surface. Contact surfaces are preferably in a fixed position such that when a plurality of playing cards are assembled into a deck, a contact surface on a playing card (100) aligns with a contact surface on an adjoining playing card (100) in the deck so that an electrical connection can be established through the electronic circuitry from playing card to playing card between the top playing card in the deck and the bottom playing card in the deck.

A portion of layer comprising a semi conductive portion (112) or (114) is preferably insulating and non-conductive. Thus, for this embodiment, a semi conductive portion of the substrate layer is surrounded by an insulating portion.

In the example represented in FIG. 1, electrical signals are transferred between a layer comprising a semi conductive portion (112) or (114) and at least one layer of conductive ink on the surface of the card. Over that, a layer of clear, conductive plastic material (126) and (128) is applied, creating a conductive surface on both sides of the card.

The conductive surface of one card is able to transfer electricity or electrical signals to the conductive surface of another card, and as illustrated by the curved arrow (510) in FIG. 5, a card can be turned 180 degrees and still function properly.

Successive semi conductive layers imprinted over the layer comprising a semi conductive portion (112) or (114) may be constructed to have more resistance (or less electrical conductivity) than that of layer comprising a semi conductive portion (112) or (114). In this manner, electric current flows vertically through the semi conductive layers (as opposed to parallel with the cards surface).

FIG. 6 is an illustration of a cut-card (648) used to cut a deck of playing cards to be held by a dealer. The function of the cut-card (648) is to receive, by surface to surface contact from the deck of cards being held by the dealer, an electrical signal indicating playing card indicia and sequence information, and transmit that indicia and information to a radio frequency, or “RF,” antenna located at a gaming table, by means of the cut-card antenna at antenna layer (652).

The cut-card (648) has two opposing surfaces: a top surface and a bottom surface, which is similar to the playing card. The cut-card (648) comprises a plurality of layers between the top surface and the bottom surface. At least a portion of each outer layer forms a contact surface that is electrically conductive. Semi conductive portion (650) within cut-card substrate layer is preferably at the same relative position as a contact surface on a playing card in a deck of playing cards. Preferably, an insulating or non-conductive portion of the substrate surrounds and isolates semi conductive portion (650). This insulating or non-conductive portion is shown contained within the center rectangular area (654) within the dotted rectangle.

The cut-card (648) includes an antenna at antenna layer (652) having capability to transmit and receive a radio frequency signal. The antenna turns a modulated electrical signal from the playing cards into an RF signal. The electrical signal received by the cut-card is modulated meaning that it is not a constant flow of electricity. The electrical signal has gaps in the current, or electricity flow, and like Morse code those gaps represent information. When an electrical signal from the stack of cards moves through the cut-card's antenna a modulated electromagnetic field is created having a modulation as the field is turned off and on at a very high rate as a result of gapped energy moving through the antenna wire.

Each time that the electrical signal moves from playing card to playing card, the old electrical signal is remodulated or obliterated and a new signal is generated adding the identifying signal of the card receiving the electrical signal, generally at the end of the old electrical signal. The signal is very short with the first card, but grows with each playing card in the deck, for example, to a 52 digit serial number after all of the cards in a 52-card deck have added their electrical signal.

Some games might be played using two jokers typically found in a deck of cards, bringing the number of cards in a typical deck to 54, however in the game of “blackjack” the jokers aren't used. In an 8 deck shoe, the serial number required would be 416 digits long. This would require a very large computing capacity for each card to enable each card to add a serial number indicative of card position in the stack. The final completed signal could be too large for the last card to handle. Therefore, a serial number may not be used. Rather, simply a unique identifying electrical signal is produced by each card. A unique identifying electrical signal does not have to contain data in order to indicate indicia of a playing card. It simply must be a recognizable signal by the transceiver/computer.

The computer has a preprogrammed list of fifty two signal responses, each linked to a particular playing card's indicia. When an electrical signal is received by the transceiver, the computer can compare the incoming signal to its preprogrammed list of potential signals, and determine the indicia that the incoming signal represents.

Each card adds its own identifying electrical signal to a signal received and passes it to the next card. When the cut-card receives the electrical signal from the last card which is adjacent to the cut-card, it is receiving a modulated signal containing sequence information, for example for 52 cards. That sequence information is in the form of a single modulated signal transmitted from the last card and it is ready to transmit “as is” from the cut-card antenna at antenna layer (652).

Although the passed-on electrical signal has been described as being expunged with the energy from the old signal contributing to the formation of the new signal, it is contemplated that a passed-on electrical signal can endure intact throughout the sequencing process, where each card adds its own unique identifying signal to a received signal, and both signals are transferred to the next card and so forth. After the last card has added its own identifying signal, a plurality of individual signals will exist (fifty-two for a single deck and 416 for an eight-deck shoe), which can be interpreted by a receiver.

The antenna in antenna layer (652) may be situated adjacent to electromagnetic field absorbing material (653) in a layer among the plurality of layers constituting the cut-card (648). The antenna layer comprises a length of wire having two ends, wherein the wire is coiled around the perimeter of the cut-card with one end of the wire electrically connected to the layer comprising a semi conductive portion (650) and the other end of the wire is electrically connected to the semi conductive surface layer (674), comprising the bottom surface of the cut-card.

The cut-card (648) has an antenna in antenna layer (652) electrically connected between the contact surfaces. The cut-card's antenna converts the electrical signal received from a playing card to a radio frequency transmission signal.

A hand-held deck of playing cards may be constructed in a similar conductive layering manner as cards designed for a shoe. In a live card game, the cards would be shuffled by the dealer, and cut by a player with the cut-card, which automatically ends up at the bottom of the stack after being cut.

The identifying signal from each card is kept in sequence, and is transferred by surface contact on each card, from card to card, until the sequenced signal is received by the bottom cut-card (648). The cut-card (648) has an antenna in antenna layer (652), preferably imprinted, that is able to generate an electromotive force voltage by coupling with an external alternating electro-magnetic field.

The table antenna transmits energizing RF signals to the cut-card in the traditional manner, by alternating an electro-magnetic field, in order to trigger the response.

The deck of playing cards being held in the dealer's hand is then energized by the antenna on the bottom cut-card (648).

It is known in the art that a human finger can create a closed circuit when in contact with both sides of a clear conductive material.

A dealer dealing a hand-dealt deck of cards will generally hold the deck with his fingers making contact with the bottom surface of the bottom card, in this case the cut-card, and his thumb intermittently making contact with the top surface of the top card as he deals each card off of the top of the deck. Thus the dealer, by dealing or holding the cards, in effect closes the circuit, which will usually consist of a collection of in-line circuitry stacked one on top of the other, within the stack of cards being held by the dealer.

In an alternative embodiment, the dealer may wear a glove (800), as shown in FIG. 8, having a conductive path (810) from the thumb to the forefingers, or a clear or flesh tone conductive material could be applied to the hand, fingers and thumb, thus making positive contact with the top and bottom surface of the deck, creating said conductive path, and allowing current to flow.

Voltage is generated by the antenna on the cut-card as discussed above, and current first flows through the dealer's hand and to the top card in the deck, then down through the deck, retaining the electrical signal indicating the sequence of cards, and then back to the antenna on the cut-card where the sequenced signal is transmitted to the table antenna.

The table antenna is connected to a transceiver which is configured to receive the RF signals from the cut-card, and to send and receive RF signals at a rate of about a fraction of a second per signal.

The transceiver is connected to a system computer that is configured to interpret the RF signals received, identify the card associated with said RF signals, and determine the content and order of the cards in the stack of cards being held by the dealer.

The computer is further configured with code means to determine a dealt card by its absence, or lack of an identifying signal from the hand-held deck, after having received that same identifying signal during the previous interrogation.

In a hand-dealt card game, as with a shoe-dealt game, the number of participants at the table can be determined by the pace or rhythm of the game as previously described and initial hands can be determined for each participant.

Just as in a shoe-dealt game, once the number of players is established either manually by casino personnel or automatically by the computer, and the initial hands have been dealt for the current round, the initial hands for the next round can be determined by the system computer and displayed on a monitor screen, at a remote, secure location.

After the initial deal, the computer will display the initial hands dealt to each participant, on a monitor.

The computer is also configured with code means to continually display the initial hands for a predetermined number of participants for the next round of cards to be dealt, assuming that no more cards will be dealt to a participant during the current round.

When a single card is dealt, the display on the monitor showing the hands for the next round is adjusted to reflect the next rounds initial hands according to the sequence of cards left in the stack of cards, in the dealer's hand. In this manner, the system computer continually displays on a monitor the next round's initial hand of each participant, before the initial hands are dealt.

Once the cards are dealt, the code means automatically calculates the number of participants, or the number is entered manually by casino personnel or other computer user. As previously disclosed, all dealt hands can be re-figured by the code means to reflect the correct number of participants, and then be re-displayed on the monitor screen.

FIG. 7 illustrates an exploded side view of a conductive, RF enabled cut-card (648), shown in FIG. 6. Cut-card (748) may include a layer comprising a semi conductive portion (758), which may be made of paper, plastic, or any other suitable material, or combination of materials.

The cut-card preferably has a plurality of layers from the top surface to the bottom surface. The layers may comprise: a semi conductive surface layer (762); an optional first inner insulating layer (760); an optional battery layer (790); a layer comprising a semi conductive portion (758); an optional electrically insulating layer (764); an optional conductive contact layer (666); an antenna layer (652); a dielectric layer (770); an optional conductive contact layer (672); and, a semi conductive surface layer (674). The layers may be in any order that provides a workable cut-card.

The cut-card (648) is used when it resides next to a playing card in a deck held by a dealer. A cut-card (648) must be constructed so that metallic circuitry, conductive ink, and clear conductive coating on a playing card does not interfere with the operation of the antenna in antenna layer (652) on cut-card (648). Thus, cut-card layer comprising a semi conductive portion (758) preferably consists of an electromagnetic field absorbing material. Such material is well known in the art.

In a preferred embodiment, electromagnetic field absorbing material comprises the perimeter of the cut-card substrate, thus adequately shielding the cut-card's antenna in antenna layer (652), as shown in FIG. 6, from interfering metallic particles on the playing cards.

In a further preferred embodiment, the cut-card (648) also comprises a semi conductive portion (650) within its substrate, as is illustrated in FIG. 6; the semi conductive portion (650) has a high conductibility through which current can pass.

The semi conductive portion (650) of the cut-card substrate may be isolated by an insulating or non-conductive portion within the substrate as is represented by the rectangular area (654) surrounding the semi conductive portion (650) in FIG. 6.

Therefore, in a preferred embodiment, layer comprising a semi conductive portion (758) in FIG. 7 may comprise three separate portions; a semi conductive portion within an insulating portion, and an electromagnetic field absorbing portion around its perimeter.

Alternately, the electromagnetic field absorbing portion may be applied to the cut-card substrate, namely, the layer comprising a semi conductive portion (758), as a separate layer. Above the layer comprising a semi conductive portion (758) is shown an optional insulating layer (760) and above that, a semi conductive surface layer (762) is shown.

Semi conductive surface layer (762) is electrically conductive, and can receive by surface to surface contact, electrical signals from the bottom surface of the stack of conductive playing cards.

In FIG. 7, below the layer comprising a semi conductive portion (758), an optional insulating layer (764) is shown. One purpose of an insulating layer (764) is to insulate the cut-card's antenna in antenna layer (652) from the electromagnetic field absorbing material contained within the cut-card's substrate (which is preferably located around its perimeter).

Below the insulating layer (764) in FIG. 7, an optional conductive contact layer (666) is shown. The optional conductive contact layer (666) may be in the form of a conductive contact layer (666), as shown in FIG. 6. The conductive contact layer (666) is to provide positive contact of semi-conductive portion (650) within cut-card substrate to the antenna in antenna layer (652), which is preferably imprinted on the cut-card substrate.

Positive conductive contact between layers is shown in FIG. 7 by the vertical lines, and the positive contact points are represented by the small circles at each end of the vertical lines in the diagram.

However, it should be noted that additional layers other than those layers shown “joined” by the vertical lines and contact points, actually make conductive contact with each other such as the semi conductive portion (650) within cut-card layer comprising a semi conductive portion (758) and semi conductive surface layer (762) in FIG. 7.

Although the antenna layer (652) is shown as a single layer in FIG. 7, it is contemplated that antenna layer (652) may be comprised of three layers, two conductive layers divided by a dielectric layer.

Below antenna layer (652) in FIG. 7, is shown a dielectric layer (770).

Referring to FIG. 6 and FIG. 7, the dielectric layer (770) is applied over most of the antenna in antenna layer (652) and over semi conductive portion (650) within cut-card substrate, and conductive contact layer (666) in order to insulate those layers from succeeding conductive layers.

Below dielectric layer (770) in FIG. 7, is shown optional conductive contact layer (672) and below conductive contact layer (672) is shown a fill-in semi conductive surface layer (674). Fill-in semi conductive surface layer (674) is electrically conductive and can pass an electrical current from the cut-cards antenna to the dealer's forefingers.

In one embodiment of the present invention, the other end of the cut-card's antenna in antenna layer (652) is connected to semi conductive surface layer (674) by the above mentioned conductive contact layer (672) as is shown in FIG. 6. The purpose of conductive contact layer (672) is for the cut-cards antenna in antenna layer (652) to make positive contact with the fill-in semi conductive surface layer (674).

Although the antenna layer (652) in FIG. 7 and the conductive contact layer (666) and the conductive contact layer (672) are shown as separate layers, they may be applied as one layer, as a single printing step. Therefore, in FIG. 6, corresponding antenna layer (652), and layers (666), and (672) may be applied as a single layer, as a single printing step. Likewise, in FIG. 1, conductive contact layers (108) and (110) and electronic circuitry layers (102) may be applied as a single layer, or from a single layer of conductive film as with laser ablation techniques.

Although the different layers are shown as extending all the way across the card in FIG. 7, it is contemplated that each layer may only comprise a portion of the exposed surface area on the cut-card.

Each layer may also be one or more of conductive, semi-conductive, or dielectric layers. Additionally, in FIG. 7, any combination of layers may be used in order for the cut-card to obtain electrical conductivity and RF functionality.

Alternatively, a single layer, or group of layers such as electronic circuitry layers (102) in FIG. 1 may be “pan caked” comprising two or more layers or groups of layers, if there is not enough surface area on the card to imprint all of the circuitry for a particular layer, in one layer.

Any number of printing methods known in the arts may be used in the manufacture of conductive playing cards and the imprinted circuitry contained within, nonexclusively including: inkjet, lithography, flexography, gravure, screen, laser ablation, surface energy modification, and micro-contact printing.

In order to overcome the electrical resistance in a dealer's hand and the resistance in the semi conductive layers in the stack of cards, a battery may be included in each playing card in the stack and/or the cut-card.

In FIG. 7, the battery layer (790) is shown directly above the layer comprising a semi conductive portion (758), however the battery may be positioned among any of the layers shown in FIG. 1 and FIG. 7, that is, between the top surface and the bottom surface. The battery may be imprinted or constructed according to the teachings well known in the art, such as for example, applying a layered organic battery using relatively low temperatures so as to not degrade the substrate and organic layers of the battery.

One or more of the batteries may be used, which activate upon an energizing signal received by the antenna on the cut-card. Battery power increases applied voltage to the stack of cards, creating an electrical current which in turn energizes the electronic circuitry in the playing cards. A battery may be included on each card in the deck and/or the cut-card. In this manner, electrical resistance in the stack of cards and the dealer's hand that might otherwise prevent the electronic circuits from energizing is overcome.

An electronic circuit may also be included in the cut-card. The electronic circuit on the cut card may consist of a single circuit meant to open or close, and may be adapted when imprinted batteries are used. After receiving an energizing RF signal from the table antenna by the cut-card's antenna, the open circuit would close on the cut-card antenna's conductive path, closing the circuit among the collection of stacked circuits among the stack of playing cards allowing current to flow. The closed circuit would allow stored energy in each playing card's battery to energize each card's circuitry with more electrical energy than the energy from an RF transmission alone, and therefore electricity can flow through the more resistive elements, such as the dealer's hand and the semi conductive layers.

An organic battery imprinted on each card is re-charged in a charging unit in a matter of minutes, and the batteries are expected to last through a thousand charge cycles.

The conductive laminated structure of the playing cards, according to the current disclosure, lends itself well to adaptation of an imprinted organic battery to be positioned among each cards layered structure, using the same or similar manufacturing and printing techniques; and for all of the batteries within the stack of cards to be charged simultaneously in a separate charging unit. The charging unit makes electrical contact with the top surface of the top card in the stack of cards, and the bottom surface of the bottom card in the stack, thus allowing current to flow, and for each battery to be recharged in-line.

The conductive layering of the present invention enables the deck to be checked to determine if it is complete, before and after it is introduced into a card game. The means for checking a deck's completeness may be located at the gaming table such as the discard tray, or it may be located remotely such as the pit boss's station or a back room. The playing cards would be placed on a conductive base making electrical contact with the bottom of the stack of cards, while an attached conductive element makes contact with, and supplies current to the top of the stack of cards.

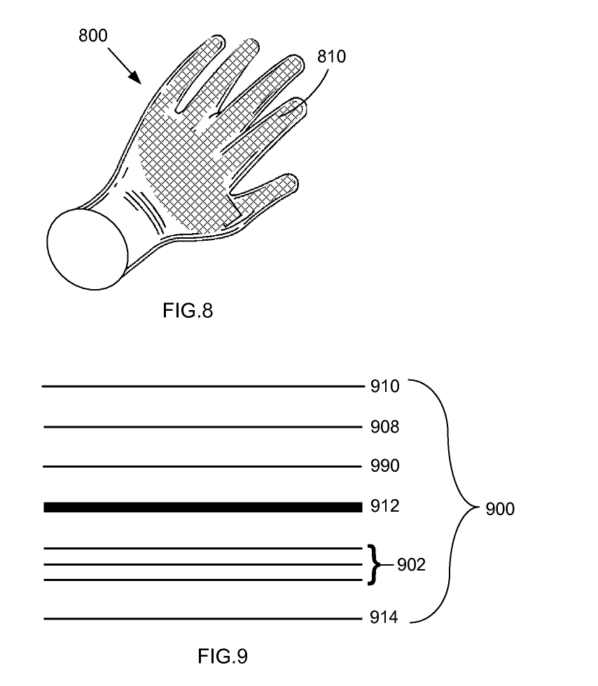

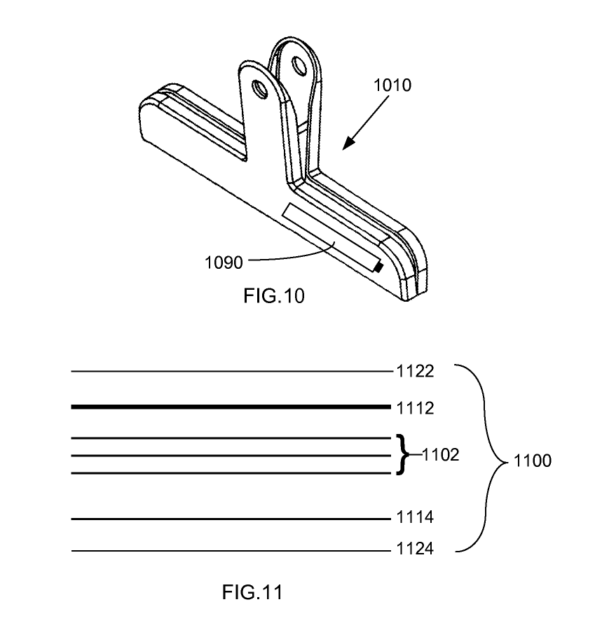

FIG. 9 illustrates an exploded side view of an image displaying card (900) that is an alternate embodiment of a similarly constructed layered playing card of the present invention. The image displaying card is used in an amusement game where playing cards according to the invention are held in a player's hand.

The image displaying card has two opposing surfaces, a top surface and a bottom surface and comprises a plurality of layers between the top surface and the bottom surface. At least a portion of each outer layer forms a contact surface that is electrically conductive.

The image displaying card (900) includes a transparent semi conductive layer (910) located on the top side of the image displaying card (900) and with means for displaying an image representing a playing card when energized through the contact surface. Such means for displaying are well known in the art. The layer (908) comprising the means for producing an image may consist of several layers: one or more dye layers, one or more conductive or semi conductive layers, and one or more insulating layers. For these embodiments, a transparent conductive layer faces the player holding the cards. An example is a color display behind a flexible, transparent, conductive surface layer made by imprinting florescent dyes, circuitry, insulating, and semi conductive layers using mostly standard printing equipment, similar to that described in U.S. Pat. No. 6,245,393.

In FIG. 9, preferred layers of the image displaying card (900) from top to bottom of the FIG. 9 are: a transparent semi conductive surface layer (910); the layer (908) comprising the means for producing an image; an optional battery layer (990); a substrate layer having a semi conductive portion (912); electronic circuitry layers (902), may consist of more or less than three layers, however, only three are shown; fill-in semi conductive film layer (914). Any of the disclosed layers may be separated by insulating or non-conductive layers.

The image displaying card includes electronic circuitry connected between the contact surfaces such that when a contact surface is electrically energized, the electronic circuitry enables the display and analysis of images representing the electrical signals received from playing cards in electrical contact therewith. The electronic circuitry, as is discussed above, is imprinted on the substrate layer having a semi conductive portion (912). The imprinted electronic circuitry has code means giving it logistic and operative capabilities.

The image displaying card shows an image of a playing card being held, or an alpha-numerical representation of its suit and numerical value.

The image displaying card optionally includes code means to organize each card being held by information displayed on the image displaying card, in a logical way, organizing by suit, numerical value, and giving playing advice.

In use, the image displaying card is placed in front of, and making electrical contact with playing cards held in a participant's hand. It is preferably placed at the bottom of a hand of cards, and when the cards are held in a fanned configuration, the image displaying card faces the person holding the cards, and so the other players would not be able to see the image just as the players can't see the faces of cards being held by a player.

By employing the currently disclosed conductive layering techniques, the image displaying card may be energized from the surface to surface contact with the other cards being held having the batteries, and/or said image displaying card may have an internal battery within its own structure. The imprinted battery may be located, such as shown in FIG. 9, or it may be located anywhere else between the outer layer on the top side and the outer layer on the bottom side.

The image displaying card is held by a participant in front of the other cards that are also being held, and it can display the entire collection of cards in the participants hand by a plurality of flexible OLED's imprinted within its layered structure.

The cards may be held together in a stack, or they may be held in a fanned-out configuration so that a portion of each card can be seen by the participant.

Furthermore, an image on the image displaying card could organize the playing cards being held as to rank and/or suit, or the image could offer constructive advice as to what card to discard, how to play, the participants total added hand value, etc.

The image displaying card may also comprise an electrically conductive clip, or alternately a conductive clip (1010) in FIG. 10, having inner conductive surface areas may be separate from the image displaying card, to be clipped to the front and back surfaces of the playing cards (100) and image displaying card (900) being held, thus closing the circuit to the collection of stacked circuitry in the playing cards (100). Thus, the clip (610) or (1010) is electrically conductive and designed to make contact with the top surface and the bottom surface of a stack held by a player, the stack comprising a plurality of playing cards and the image-displaying card.

In FIG. 6, a conductive clip (610) is shown which may be used with a cut card to make top and bottom contact and/or provide electrical energy to the stack of cards. Conductive clip (610) may take a different embodiment than that shown such as a curved metal clip that can fit in the dealers hand and only having minimal tension so that a single card can be dealt off of the top of the stack.

Alternatively, as previously disclosed, a conductive glove (800) may be worn by the participant, or a conductive substance may be applied to the participant's hand, closing the collection of circuits, and allowing current to flow through the stack of cards.

It is contemplated that such a system employing a front image displaying card could be used in many card games where the cards are held in the participant's hand, nonexclusively including: poker, gin rummy, pai gow, bridge, canasta, etc.

In a preferred embodiment, a battery (1090) for energizing the image displaying card and/or the playing cards is incorporated within the conductive clip (1010), further enabling regular conductive playing cards (those cards not having a battery) to be used.

Alternately, each card in the deck could have the capability to display an image, with the first card, or front card of the group of cards being held by the participant, being configured to energize and display the relevant information.

In yet a further alternate embodiment of the present invention, the conductive clip (1010) could be incorporated into the surface of a gaming table, in front of the dealer, adjacent to where the dealer's cards are placed, during a regular round of cards.

In the game of blackjack, there is a need for an automatic, non line-of-sight system for determining the dealer's hand, and as to whether or not the dealer has blackjack. When the dealer deals to his own hand in the game of blackjack, he will deal one card facing up, on top of another card facing down, just in front of said conductive clip at the game table.

In accordance with the present invention, when it is proper to reveal whether or not the dealer has blackjack (but not reveal to the participants the dealer's bottom, face down card) the dealer would slide his two cards across the felt, backwards (towards the dealer) and between the two inner, conductive areas on the clip (1010), thus making conductive contact with the top surface of the top card, and the bottom surface of the bottom card, allowing current to flow through the dealer's two cards.

Preferably, a plastic cover may be placed over the conductive clip, having an opening on one end where the cards will enter when being slid underneath.

One problem that presents itself with this arrangement is that one of the dealer's cards is “flipped-over” after being dealt, with the two cards residing with the back surface of one card against the back surface of another.

Although current can flow through the two cards when they are arranged “back-to back”, circuitry in each card is generally designed for electricity to flow in a single, particular direction; otherwise the circuitry will not function.

Therefore, when the dealer's two cards are interrogated by an electrically connected transceiver, only one card would have the capability of returning an identifying response signal.

In order to solve this problem, electronic circuitry can be designed so that electricity can flow in both directions through said circuitry, and after the cards have been interrogated once, the polarity can be reversed, sending a second interrogation signal moving through the cards in the opposite direction.

This would allow the “flipped” card, (or either card) to respond to a second interrogation signal after being irresponsive to a first interrogation signal.

In this manner, the identities of both cards can be determined, and the system would then signal to the participants whether or not the dealer has a “blackjack” (an ace and a ten value card) by the illumination of an indicator light located at the game table, or by any other means known within the arts.

A conductive layered structure (1100) in FIG. 11 for any flat substrate, similar to that disclosed for playing cards, may be adapted to other applications. For example, any paper indicating indicia or information, a badge, a ticket, a picture, casino chips or plaques, even money could be made “smart” with the adoption of inner circuitry (1102) between two semi conductive layers (1112 and 1114), where at least one of the layers is a substrate, and where current flows between layers (1112) and (1114) and the outer layers (1122 and 1124). When placed in a stack each individual article containing circuitry is determined to be present in the stack and its relative position in the stack is determined as well. Paper money or casino chips for instance, when stacked could determine the amount in the stack by the creation of an electrical signal. A group of medical records for existing patients can be placed in various stacks in order to determine where a patient is regarding treatment, one stack or location of a record indicative of a treatment step or progress level.

Semi conductive layers (1112) and (1114) may be constructed similarly to that of the previously disclosed playing card (100). Semi conductive layers (1112) and (1114) may be semi-conductive across the entire layer, or only a portion of a layer.

Thus, in these applications, an embodiment of the invention is a conductive layered structure (1100) bearing indicia having a top side and a bottom side, wherein one of the layers serves as a substrate, comprising: a plurality of layers comprising an outer layer on the top side (1122) and an outer layer on the bottom side (1124) wherein at least a portion of each outer layer (1122 and 1124) forms a contact surface that is electrically conductive; and, electronic circuitry electrically connected between the contact surfaces such that when a contact surface is electrically energized the electronic circuit generates an electrical signal that identifies indicia on the conductive layered structure. Layers (1122) and (1124) each represent at least one layer of conductive ink applied to conductive layered structure (1100). Although conductive layered structure (1100) is shown with both the top side and the bottom side imprinted with conductive ink, it is contemplated that conductive layered structure (1100) may only have one side imprinted with conductive ink. The term “conductive ink” used herein includes any conductive substance having marking characteristics such as ink, paint, oil, pigment, dye or stain. Additionally, a stack containing a plurality of conductive layered structures (1100), each having electronic circuitry which emit an identifying signal, can be formed wherein the substrates are interchangeable as to their location among the stack, with their new location being represented by a new electrical signal created.

The conductive layered structure (1100) may be assembled into a device for identifying indicia in a stack of conductive layered structures and for identifying the order of the conductive layered structures present in the stack. Analogous to the shoe for a playing card, the device comprises a plurality of the conductive layered structures (1100) arranged in a stack wherein the electronic circuitry comprises means for receiving an electrical signal from a conductive layered structure adjacent to it in the stack, and means for transmitting a new electrical signal identifying the conductive layered structure in which the electronic circuitry is located, said new electrical signal appended to the electrical signal received. This electronic circuitry is the same as is discussed above for the playing card.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

What is claimed is:

1. A playing card having a top side and a bottom side wherein one side shows indicia unique to the playing card, the playing card comprising:
(a) a plurality of layers comprising an outer layer on the top side and an outer layer on the bottom side wherein at least a portion of each outer layer forms a contact surface that is electrically conductive; and,
(b) electronic circuitry electrically connected between the contact surfaces such that when a contact surface is electrically energized the electronic circuitry generates an electrical signal that identifies the indicia of the playing card.

2. The playing card of claim 1 further comprising a plurality of layers, constructed symmetrically from top side to bottom side wherein the half comprising the top side to midpoint comprises:
(a) an outer layer of clear semi conductive plastic material;
(b) a semi-conductive ink layer;
(c) a layer comprising a semi conductive portion; and,
(d) an electronic circuitry layer that is electrically connected to the layer comprising a semi conductive portion.

3. The playing card of claim 1 wherein the contact surfaces are in a fixed position such that when a plurality of such playing cards are assembled into a deck, a contact surface on a playing card aligns with a contact surface on an adjoining playing card in the deck so that an electrical connection can be established through the electronic circuitry from playing card to playing card between the top playing card in the deck and the bottom playing card in the deck.

4. The playing card of claim 1 wherein each contact surface is applied to a portion of a layer such that an edge of the playing card is non-conductive.

5. An amusement game comprising a deck of a plurality of playing cards of claim 1 wherein each of up to 52 playing cards has unique indicia comprising a suit and a face value.

6. The amusement game of claim 5 wherein the electronic circuitry comprises means for receiving an electrical signal from a playing card adjacent to it in the deck and transmitting a new electrical signal with the indicia of the playing card in which the electronic circuitry is located appended to the electrical signal received.

7. The amusement game of claim 6 further comprising a shoe for holding the deck, wherein the shoe comprises
(a) an energy source to electrically energize the contact surfaces of all the cards in the deck by applying an electrical potential difference between the contact surfaces on the top and bottom playing cards in the deck;
(b) a transceiver to send electrical current to one of the electrical contact points and receive an electrical signal indicating playing card indicia and sequence information from the other electrical contact point;
(c) a means for relaying to a computer said electrical signal comprising the indicia and sequence information; and,
(d) a computer connected to the means for relaying configured to analyze the received signal and interface with a user.

8. The amusement game of claim 7 wherein the shoe further comprises microchip circuitry with code means having logistic and time recognition capabilities.

9. The amusement game of claim 8 wherein the computer comprises code means to correlate the indicia of each playing card in its sequence in the deck; identify a playing card that has been dealt from the shoe by its absence from the deck; and determine the order of a group of cards that have been dealt.

10. The amusement game of claim 6 further comprising an image-displaying card having two opposing surfaces, a top surface and a bottom surface, the image displaying card comprising:
(a) a plurality of layers between the top surface and the bottom surface wherein at least a portion of each outer layer forms a contact surface that is electrically conductive;
(b) a transparent layer located on one surface with means for displaying an image representing a playing card when energized through the contact surface; and,
(c) electronic circuitry connected between the contact surfaces such that when a contact surface is electrically energized, the electronic circuitry enables the display and analysis of images representing the electrical signals received from playing cards in electrical contact therewith.

11. The amusement game of claim 10 further comprising a clip that is electrically conductive to make contact with the top surface and the bottom surface of a stack held by a player, the stack comprising a plurality of playing cards and the image-displaying card.

12. The amusement game of claim 11 further comprising a battery incorporated within the clip.

13. The amusement game of claim 10 further comprising an imprinted battery located between the top surface and the bottom surface.

14. The amusement game of claim 6 further comprising a cut-card used to cut a deck of playing cards, the cut-card having two opposing surfaces, a top surface and a bottom surface, the cut-card comprising:
(a) a plurality of layers between the top surface and the bottom surface wherein at least a portion of each outer layer forms a contact surface that is electrically conductive, wherein a portion of each such contact surface is at the same relative position as a contact surface on a playing card in the deck of playing cards; and,
(b) an antenna having capability to transmit and receive a radio frequency signal.

15. The amusement game of claim 14 further comprising an imprinted battery between the top surface and the bottom surface.

16. The amusement game of claim 14 wherein the cut-card plurality of layers from the top surface to the bottom surface comprise:
(a) a semi conductive surface layer;
(b) a layer comprising a semi conductive portion;
(c) an antenna layer;
(d) a dielectric layer; and,
(e) a semi conductive surface layer.

17. The amusement game of claim 16 wherein the antenna layer comprises a length of wire having two ends, wherein the wire is coiled around the perimeter of the cut-card with one end of the wire electrically connected to the layer comprising a semi conductive portion and the other end of the wire electrically connected to the semi conductive surface layer.

18. A conductive layered structure bearing indicia having a top side and a bottom side, wherein one of the layers serves as a substrate, comprising:
(a) a plurality of layers comprising an outer layer on the top side and an outer layer on the bottom side wherein at least a portion of each outer layer forms a contact surface that is electrically conductive, and,
(b) electronic circuitry electrically connected between the contact surfaces such that when a contact surface is electrically energized the electronic circuit generates an electrical signal that identifies indicia on the conductive layered structure.

19. A device for identifying indicia in a stack of conductive layered structures of claim 18 and for identifying the order of said conductive layered structures present in the stack, the device comprising a plurality of the conductive layered structures of claim 18 arranged in a stack wherein the electronic circuitry comprises means for receiving an electrical signal from a conductive layered structure adjacent to it in the stack, and means for transmitting a new electrical signal identifying the conductive layered structure in which the electronic circuitry is located, said new electrical signal appended to the electrical signal received.

20. The stack of a plurality of conductive layered structures of claim 19 wherein an electrical signal is created indicating a layered order to the plurality of conductive layered structures.
